(19) United States
(12) Patent Application Publication
(10) Pub. No.: US 2026/0029190 A1
(43) Pub. Date: Jan. 29, 2026

(54) INTELLIGENT TEMPERATURE CONTROL SYSTEM AND METHOD FOR VERY FAST CHILLING OF LIVESTOCK AND POULTRY MEAT

(71) Applicant: INSTITUTE OF FOOD SCIENCE AND TECHNOLOGY, CHINESE ACADEMY OF AGRICULTURAL SCIENCES, Beijing (CN)

(72) Inventors: Dequan ZHANG, Beijing (CN); Dongmei LENG, Beijing (CN); Xin LI, Beijing (CN); Chengli HOU, Beijing (CN); Li CHEN, Beijing (CN); Zhenyu WANG, Beijing (CN)

(73) Assignee: INSTITUTE OF FOOD SCIENCE AND TECHNOLOGY, CHINESE ACADEMY OF AGRICULTURAL SCIENCES, Beijing (CN)

(21) Appl. No.: 19/278,793

(22) Filed: Jul. 24, 2025

(30) Foreign Application Priority Data
Jul. 24, 2024 (CN) 202410993541.2

(51) Int. Cl. F25D 29/00; F25D 3/11; G05B 13/02

(52) U.S. Cl. CPC F25D 29/001; F25D 3/11; G05B 13/027; F25D 2400/28; F25D 2600/04

(57) ABSTRACT

The present disclosure discloses an intelligent temperature control method for very fast chilling of livestock and poultry meat, comprising: adopting a carbon dioxide refrigeration mode, monitoring a real-time temperature change, judging whether an very fast chilling requirement is met or not according to a set threshold, if not, comparing a difference with the threshold, determining a adjusting amount, changing a valve opening degree; acquiring data of the chilling rate, liquid supply and valve opening degree, adopting a neural network to analyze, learning a data set, training a control model, predicting liquid supply, adjusting, controlling a valve opening degree of a refrigeration system. The present disclosure further discloses an intelligent temperature control system for very fast chilling of livestock and poultry meat.

### CROSS-REFERENCE TO RELATED APPLICATION

This application claims the priority benefit of China application serial no. 202410993541.2, filed on Jul. 24, 2024. The entirety of the above-mentioned patent application is hereby incorporated by reference herein and made a part of this specification.

### BACKGROUND

### Technical Field

The present disclosure relates to the technical field of intelligent control of livestock and poultry meat cooling systems. More specifically, the present disclosure relates to an intelligent temperature control system and method for very fast chilling of livestock and poultry meat.

### Description of Related Art

Annual output and consumption of livestock and poultry meat in China rank first in the world, wherein fresh livestock and poultry meat accounts for about 80% of China's meat consumption. China mainly produces and consumes fresh livestock and poultry meat in a pre-rigor stage (that is, slaughtered and sold immediately). Research show that the fresh meat before rigor mortis is more suitable for Chinese style cooking and processing. The livestock and poultry are slaughtered and then go through four stages including pre-rigor, rigor mortis, release of rigor and spoilage, but problems of difficult quality maintaining and high loss of the livestock and poultry meat due to the lack of rigor mortis inhibiting technology in an existing livestock and poultry slaughtering and processing link are prominent, so a pre-rigor quality maintaining technology needs to be broken through urgently.

The cooling process of the livestock and poultry meat after slaughter is an important link affecting the quality of the livestock and poultry meat. However, there are some problems such as low chilling rate, high energy consumption and environmental pollution caused by refrigerants in the cooling process of the livestock and poultry meat at present. It is urgent to develop a cooling technology that can suppress rigor mortis and ensure quality. Natural refrigerants such as carbon dioxide refrigerants, which have no pollution to the environment and have good heat transfer effect, are adopted, and a purpose of suppressing rigor mortis and ensuring quality of the livestock and poultry meat, improving a cooling efficiency and reducing energy consumption is realized through precise control between a refrigeration system and a chilling rate of the livestock and poultry meat.

### SUMMARY

One object of the present disclosure is to solve at least the above problems and to provide at least advantages that will be described hereinafter.

Another object of the present disclosure is to provide an intelligent temperature control system and method for very fast chilling of livestock and poultry meat, which can dynamically adjust a cooling capacity according to a cooling demand, thus not only meeting a demand of the very fast chilling of the livestock and poultry meat, but also avoiding ineffective consumption of energy efficiency.

In order to achieve these objects and other advantages of the present disclosure, an intelligent temperature control method for very fast chilling of livestock and poultry meat by adopting a carbon dioxide refrigeration mode is provided, wherein the method comprises:
obtaining a temperature and a time of the livestock and poultry meat/carcass during a current data acquisition cycle in a cooling environment; and
predicting a refrigerant liquid supply adjusting amount and a refrigerant valve opening degree of a refrigeration system in next data acquisition cycle by using a pre-trained BP neural network model according to the temperature and the time of the livestock and poultry meat during the current data acquisition period in the cooling environment.

Preferably, a method for training the BP neural network model comprises:
obtaining an initial temperature and an initial time of the livestock and poultry meat when entering the cooling environment, and recording the initial temperature and the initial time as a temperature-time sequence (T₀ᵢ, t₀ᵢ), wherein i is a number of different livestock and poultry meat, and there are n livestock meat individuals in total;
obtaining a temperature and a time of the livestock and poultry meat during an m^{th} data acquisition cycle in the cooling environment, and recording the temperature and the time as a temperature-time sequence (Tₘᵢ, tₘᵢ);
calculating a chilling rate Vₘᵢ=(Tₘᵢ−T₀ᵢ)/(tₘᵢ−t₀ᵢ) of the livestock and poultry meat in the m^{th} data acquisition cycle;
obtaining a preset chilling rate threshold V_{g} livestock and poultry meat and a target final cooling temperature T_{g} of the livestock and poultry;
for each livestock and poultry meat individual, comparing Tₘᵢ with T_{g} and comparing Vₘᵢ with V_{g}; when all the livestock and poultry meat individuals satisfy that Tₘᵢ>T_{g} and Vₘᵢ≥V_{g}, the very fast chilling requirement being satisfied, and making no adjusting command; when at least one livestock and poultry meat individual satisfies that Tₘᵢ>T_{g} and Vₘᵢ≤V_{g}, the very fast chilling requirement being not satisfied, and calculating a refrigerant liquid supply adjusting amount Δq and a refrigerant valve opening degree K of an (m+1)^{th} data acquisition cycle; and when all the livestock and poultry meat individuals satisfy Tₘᵢ≤T_{g}, stopping the cooling; and
acquiring temperature-time sequences, refrigerant liquid supplies and refrigerant valve opening degrees in different data acquisition cycles, creating a training sample set of the BP neural network model, training the pre-constructed BP neural network model by using the training sample set, and adjusting a parameter of the BP neural network model by adopting a back propagation algorithm until the model converges or reaches maximum training times.

Preferably, a method for calculating the liquid supply adjusting amount Δq in the (m+1)^{th} data acquisition cycle comprises:
obtaining the weight Mᵢ and specific heat capacity cᵢ of each livestock and poultry meat that does not satisfy the very fast chilling requirement;
calculating a thermal load difference (ΔQ_{total difference}=ΣΔQ_{differencei}) of all the livestock and poultry meat that does not satisfy the very fast chilling requirement in the (m+1)^{th} data acquisition cycle, wherein ΔQ_{difference i} is a thermal load difference of single livestock and poultry meat that does not satisfy the very fast chilling requirement, ΔQ_{difference i}=cᵢ·V_{g}·Mᵢ·(V_{g}·Δₜ−Vₘᵢ·Δt), and Δt is a time interval of the data acquisition cycles;
obtaining preset phase-change latent heat Δh of the carbon dioxide refrigerant, and calculating phase change heat (Q_{phase-change}=Δq·Δh·Δt) of the refrigerant liquid supply adjusting amount Δq in the (m+1)^{th} data acquisition cycle;
based on that Q_{phase-change}≥ΔQ_{total difference}, deriving that Δq≥Σ[cᵢ·Mᵢ·(V_{g}−Vₘᵢ)]/Δh.

Preferably, a method for calculating the refrigerant valve opening degree K comprises:
based on a mapping relationship q=f(k) between the refrigerant liquid supply q and the valve opening degree K, deriving the refrigerant valve opening degree kₘ₊₁=f⁻¹[qₘ+Δq] in the (m+1)^{th} data acquisition cycle by calculating, wherein qₘ is a refrigerant liquid supply in the m^{th} data acquisition cycle.

Preferably, the time interval Δt of the data acquisition cycles is preset by a user.

Preferably, the livestock and poultry meat comprise all varieties of livestock and poultry meat, and parts of the livestock and poultry meat comprise carcass, sides, quarters and cut meat.

The present disclosure further provides an intelligent temperature control system for very fast chilling of livestock and poultry meat, comprising:
a real-time data acquisition module used for obtaining a temperature and a time of the livestock and poultry meat during a current data acquisition cycle in a cooling environment;
a control module predicting a refrigerant liquid supply adjusting amount and a refrigerant valve opening degree of a refrigeration system in next data acquisition cycle by using a pre-trained BP neural network model according to the temperature and the time of the livestock and poultry meat during the current data acquisition cycle in the cooling environment.

Preferably, the intelligent temperature control system for the very fast chilling of the livestock and poultry meat further comprises:
a setting module used for a user to preset the specific heat capacity of the livestock and poultry meat, the time interval of the data acquisition cycles, the chilling rate threshold and the target final cooling temperature; and
a network connection module acquiring the time online through wired or wireless communication.

The present disclosure further provides a device for very fast chilling of livestock and poultry meat, comprising:
a carbon dioxide refrigeration system;
a temperature sensor for acquiring the temperature of the livestock and poultry meat, a weight sensor for acquiring the weight of the livestock and poultry meat, a liquid supply sensor arranged in the carbon dioxide refrigeration system for acquiring the liquid supply of the carbon dioxide refrigerant, and an opening degree sensor arranged in the carbon dioxide refrigeration system for acquiring the valve opening degree of the carbon dioxide refrigerant;
the intelligent temperature control system for the very fast chilling of the livestock and poultry meat mentioned above, which is respectively connected with the temperature sensor, the weight sensor, the liquid supply sensor and the opening degree sensor;
an execution unit respectively connected with the intelligent temperature control system for the very fast chilling of the livestock and poultry meat and a refrigerant valve in the carbon dioxide refrigeration system, and used for receiving an adjusting instruction sent by the intelligent temperature control system for the very fast chilling of the livestock and poultry meat, and controlling an action of the refrigerant valve in the carbon dioxide refrigeration system according to the adjusting instruction.

The present disclosure further provides an electronic device, comprising: at least one processor and a memory in communication connection with the at least one processor, wherein the memory stores an instruction executable by the at least one processor, and the instruction is executed by the at least one processor to enable the at least one processor to execute the intelligent temperature control method for the very fast chilling of the livestock and poultry meat mentioned above.

The present disclosure at least comprises the following beneficial effects:

1. A direct relationship between the chilling rate of the livestock and poultry meat and the liquid supply of the refrigeration system is established to realize accurate judgment of a cooling capacity demand, the cooling capacity is dynamically adjusted in real time according to the chilling rate demand of the livestock and poultry meat, realize accurate cooling of the livestock and poultry meat, make the chilling rate of the livestock meat be greater than 15° C./h, and the chilling rate of the poultry meat be greater than 22° C./h, meet the demand of the very fast chilling of the livestock and poultry meat, effectively inhibit occurrence of a rigor mortis process and maintain a meat quality before rigor mortis;

2. The carbon dioxide refrigeration system is adopted, which meets the requirements of environmental protection. According to the cooling demand of the livestock and poultry meat, the refrigeration capacity is dynamically adjusted to realize the precise control of the refrigeration system.

3. The present disclosure is suitable for a refrigeration temperature range of −35° C. to 10° C.

Other advantages, objectives and features of the present disclosure will be partially reflected by the following description, and will be partially understood by those skilled in the art through research and practice of the present disclosure.

### BRIEF DESCRIPTION OF THE DRAWINGS

FIG. 1 is a flow chart of an intelligent temperature control method for very fast chilling of livestock and poultry meat according to the present disclosure;

FIG. 2 is a schematic diagram of a BP neural network model according to the present disclosure; and

FIG. 3 is a schematic diagram of an intelligent temperature control system for very fast chilling of livestock and poultry meat according to the present disclosure.

### DESCRIPTION OF THE EMBODIMENTS

The present disclosure will be further described in detail hereinafter with reference to the drawings and embodiments, so that those skilled in the art can implement the present disclosure with reference to the specification.

It should be noted that all the experimental methods in the following embodiments are conventional methods without special instructions, and all the reagents and materials can be obtained from commercial channels without special instructions. In the description of the present disclosure, the orientations or positional relationships indicated by the terms such as “transverse”, “longitudinal”, “upper”, “lower”, “front”, “back”, “left”, “right”, “vertical”, “horizontal”, “top”, “bottom”, “inner”, “outer” and the like, refer to the orientations or positional relationships shown in the drawings, which are only intended to facilitate describing the present disclosure and simplifying the description, and do not indicate or imply that the indicated devices or elements must have a specific orientation, be constructed and operated in a specific orientation, and therefore cannot be understood as a limitation of the present disclosure.

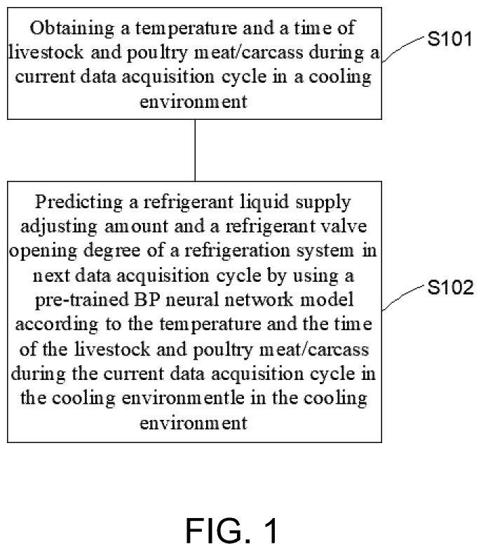

As shown in FIG. 1, embodiments of the present disclosure provide an intelligent temperature control method for very fast chilling of livestock and poultry meat by adopting a carbon dioxide refrigeration mode, wherein the method comprises:

S101: obtaining a temperature and a time of the livestock and poultry meat during a current data acquisition cycle in a cooling environment.

Specifically, the livestock and poultry meat comprises all varieties of livestock and poultry meat, and parts of the livestock and poultry meat comprise carcass, sides, quarters and cut meat. For example, after slaughter, the livestock and poultry entering a cooling room for cooling, wherein poultry and sheep are usually cooled as whole carcasses because of small size thereof, pigs are usually sides, while cattle are usually quarters.

A device for acquiring the temperature of the livestock and poultry meat may be a thermocouple. In this embodiment, in order to obtain the temperature of the livestock and poultry meat more accurately, the thermocouple is inserted into a center of a thickest position of the livestock and poultry meat to acquire and record the temperature of the livestock and poultry meat in real time.

A method for obtaining the time may be that the time is obtained online through wired or wireless communication.

The data acquisition cycle refers to a number of data acquisition times, and a current data acquisition cycle is data acquisition of the current times. Here, data acquisition when the livestock and poultry meat entering the cooling environment for the first time is recorded as 0^{th} times.

The time interval Δt of the data acquisition cycles may be preset by a user, for example, set as 5 minutes or 10 minutes, and the like. If an accuracy of the BP neural network model described below is poorer, the time interval Δt of the data acquisition cycles may be shortened and a data acquisition amount may be increased. If the accuracy of the BP neural network model described below is higher, the time interval Δt of the data acquisition cycles may be prolonged and the data acquisition amount may be decreased.

S102: adjusting amount and a refrigerant valve opening degree of a refrigeration system in next data acquisition cycle by using a pre-trained BP neural network model according to the temperature and the time of the livestock and poultry meat during the current data acquisition cycle in the cooling environment.

Specifically, a method for training the BP neural network model comprises:

S201: obtaining an initial temperature and an initial time of the livestock meat when entering the cooling environment, and recording the initial temperature and the initial time as a temperature-time sequence (T₀ᵢ, t₀ᵢ), wherein i is a number of different livestock and poultry meat, and there are n livestock meat individuals in total.

S202: obtaining a temperature and a time of the livestock and poultry meat during an m^{th} data acquisition cycle in the cooling environment, and recording the temperature and the time as a temperature-time sequence (Tₘᵢ, tₘᵢ).

S203: calculating a chilling rate Vₘᵢ=(Tₘᵢ−T₀ᵢ)/(tₘᵢ−t₀ᵢ) of the livestock and poultry meat in the m^{th} data acquisition cycle.

For example, an initial temperature-time sequence of livestock and poultry meat 1 is (T₀ᵢ, t₀ᵢ), and a temperature-time sequence of a first data acquisition cycle is (T₁₁, t₁₁), then a chilling rate of the livestock and poultry meat 1 in the first data acquisition cycle is that V₁₁−(T₁₁−T₀₁)/(t₁₁−t₀₁), and a chilling rate data set [V₁₁, V₂₁, . . . , Vₘ₁] of the livestock and poultry meat 1 in different acquisition cycles may be calculated. The same principle is applicable for other livestock and poultry meat. Chilling rate data sets of different livestock and poultry meat in different acquisition cycles may be obtained comprehensively [V₁₁, V₂₁, . . . , Vₘ₁; V₁₂, V₂₂, . . . , Vₘ₂; V₁ₙ, . . . , Vₘₙ].

S204: calculating a chilling rate Vₘᵢ=(Tₘᵢ−T₀ᵢ)/(tₘᵢ−t₀ᵢ) of the livestock and poultry meat in the m^{th} data acquisition cycle.

Here, the same chilling rate threshold V_{g} may be adopted for n pieces of livestock and poultry meat, and the same target final cooling temperature T_{g} may also be adopted for n pieces of livestock and poultry meat.

S205: for each livestock and poultry meat individual, comparing Tₘᵢ with T_{g} and comparing Vₘᵢ with V_{g}; when all the livestock and poultry meat individuals satisfy that Tₘᵢ>T_{g} and Vₘᵢ≥V_{g}, the very fast chilling requirement being satisfied, and making no adjusting command; when at least one livestock and poultry meat individual satisfies that Tₘᵢ>T_{g} and Vₘᵢ≤V_{g}, the very fast chilling requirement being not satisfied, and calculating a refrigerant liquid supply adjusting amount Δq and a refrigerant valve opening degree K of an (m+1)^{th} data acquisition cycle; and when all the livestock and poultry meat individuals satisfy Tₘᵢ≤T_{g}, stopping the cooling.

More specifically, when there are both livestock and poultry meat that meets the very fast chilling requirement and livestock and poultry meat that does not meet the very fast chilling requirement, only the temperature-time sequence of the livestock and poultry meat that does not meet the very fast chilling requirement may be acquired, and the data of the livestock and poultry meat that meets the very fast chilling requirement are no longer comprised in a data acquisition range.

More specifically, in the above-mentioned steps, a method for calculating the liquid supply adjusting amount Δq in the (m+1)^{th} data acquisition cycle comprises:

S301: obtaining the weight Mi and specific heat capacity ci of each livestock and poultry meat that does not satisfy the very fast chilling requirement.

Here, a tray or a hook with a weight sensor may be arranged in the very fast chilling device, and each livestock and poultry meat may be placed in a different tray or hung on the hook, and the weight of livestock and poultry meat may be obtained and stored through the weight sensor. In the above step S205, when the livestock and poultry meat that does not meet the very fast chilling requirement is determined through the conditions that Tₘᵢ>T_{g} and Vₘᵢ≤V_{g}, the weight Mᵢ of each livestock and poultry meat that does not meet the very fast chilling requirement can be directly obtained.

The specific heat capacity of each livestock and poultry meat may also be input into a system for storage in advance. When the livestock and poultry meat that does not meet the very fast chilling requirement is determined by the conditions that Tₘᵢ>T_{g} and Vₘᵢ≤V_{g} in the above step S205, the specific heat capacity ci of each livestock and poultry meat that does not meet the very fast chilling requirement can be directly obtained.

S302: calculating a thermal load difference (ΔQ_{total difference}=ΣΔQ_{differencei}) of all the livestock and poultry meat that does not satisfy the very fast chilling requirement in the (m+1)^{th} data acquisition cycle, wherein ΔQ_{difference i} is a thermal load difference of single livestock and poultry meat that does not satisfy the very fast chilling requirement, ΔQ_{difference i}=cᵢ·V_{g}·Mᵢ·(V_{g}·Δt−Vₘᵢ·Δt), and Δt is a time interval of the data acquisition cycles.

Here, the thermal load difference of all the livestock and poultry meat that does not meet the very fast chilling requirement refers to a difference between the thermal load generated by adopting the chilling rate in the m^{th} data acquisition cycle and the thermal load generated by adopting the chilling rate threshold V_{g} for all the livestock and poultry meat that does not meet the very fast chilling requirement.

S303: obtaining preset phase-change latent heat Δh of the carbon dioxide refrigerant, and calculating phase change heat (Q_{phase-change}=Δq·Δh·Δt) of the refrigerant liquid supply adjusting amount Δq in the (m+1)^{th} data acquisition cycle.

Because some livestock and poultry meat does not satisfy the very fast chilling requirement, it is necessary to adjust the refrigerant liquid supply to absorb more thermal load of the livestock and poultry meat when the refrigerant changes phase. The phase change heat absorbed by this part of the refrigerant liquid supply adjusting amount in the (m+1)^{th} data acquisition cycle may be obtained through this step.

S304: based on that Q_{phase-change}≥ΔQ_{total difference}, deriving that Δq≥Σ[cᵢ·Mᵢ·(V_{g}−Vₘᵢ)]/Δh.

As the thermal load difference ΔQ_{total difference} of all the livestock and poultry meat that does not meet the very fast chilling requirement and the phase-change heat Q_{phase-change} absorbed by the refrigerant liquid supply adjusting amount Δq in the (m+1)^{th} data acquisition cycle are already obtained in the previous steps, in order to make the chilling rate of all the livestock and poultry meat that does not meet the very fast chilling requirement reach the standard, it needs to at least satisfy that the Q_{phase-change}≥ΔQ_{total difference}, and based on this, a minimum value of the refrigerant liquid supply adjusting amount Δq can be obtained.

The minimum value of the refrigerant liquid supply adjusting amount Δq in the (m+1)^{th} data acquisition cycle is calculated in the above steps, and the refrigerant valve opening degree K in the (m+1)^{th} data acquisition cycle needs to be calculated according to the refrigerant liquid supply adjusting amount Δq.

More specifically, a method for calculating the refrigerant valve opening degree K comprises:
based on a mapping relationship q=f(k) between the refrigerant liquid supply q and the valve opening degree K, deriving the refrigerant valve opening degree kₘ₊₁=f⁻¹[qₘ+Δq] in the (m+1)^{th} data acquisition cycle by calculating, wherein qₘ is a refrigerant liquid supply in the m^{th} data acquisition cycle.

The mapping relationship between the refrigerant liquid supply q and the valve opening degree K may be calibrated in advance.

S206: acquiring temperature-time sequences, refrigerant liquid supplies and refrigerant valve opening degrees in different data acquisition cycles, creating a training sample set of the BP neural network model, training the pre-constructed BP neural network model by using the training sample set, and adjusting a parameter of the BP neural network model by adopting a back propagation algorithm until the model converges or reaches maximum training times.

The acquisition process of the temperature-time sequences of different livestock and poultry meat in different data acquisition cycles and the calculation process of the chilling rates of different livestock and poultry meat in different data acquisition cycles have been described in the above steps, and detailed description thereof will be omitted here.

The refrigerant liquid supply may be acquired by a liquid supply sensor preset in the carbon dioxide refrigeration system, the refrigerant liquid supply adjusting amount may be obtained by calculating a refrigerant liquid supply difference of two adjacent data acquisition cycles, and the refrigerant valve opening degree may be acquired by an opening sensor preset in the carbon dioxide refrigeration system.

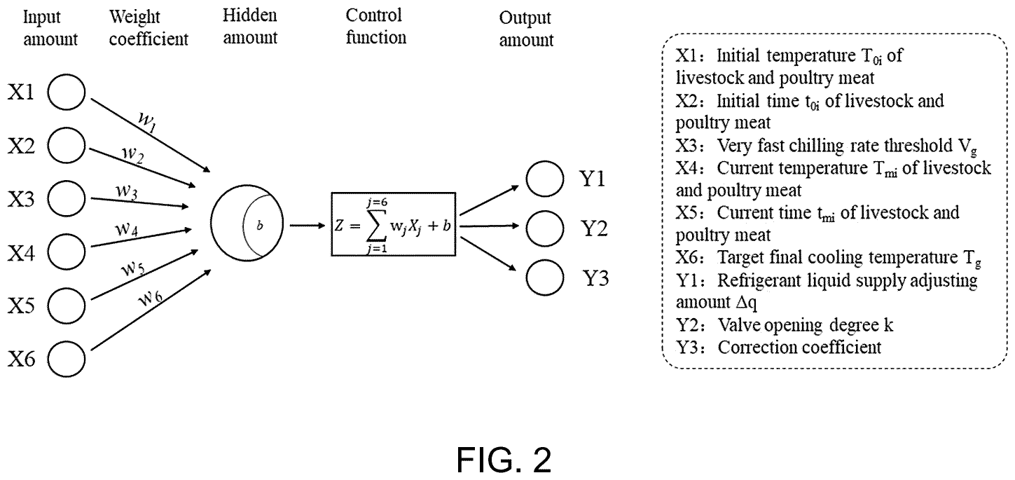

The BP neural network model may be pre-constructed, comprising an input layer, a hidden layer and an output layer. In this embodiment, in the input layer of the BP neural network model, the initial temperature of the livestock and poultry meat, the initial time of the livestock and poultry meat, the chilling rate threshold, the temperature of the livestock and poultry meat in the current data acquisition cycle, the time of the livestock and poultry meat in the current data acquisition cycle and the target final cooling temperature are selected as input nodes, the refrigerant liquid supply adjusting amount, the refrigerant valve opening degree and a model correction coefficient are selected as output nodes. Connection weights between the input layer and the hidden layer and a control function between the hidden layer and the output layer are selected as parameters to be trained, as shown in FIG. 2.

When the training sample set is adopted to train the BP neural network model: the connection weights and thresholds in the BP neural network model are initialized. Based on the temperature-time sequences of different livestock and poultry meat in different data acquisition cycles, the predicted values of the refrigerant liquid supply adjusting amount and the refrigerant valve opening degree can be obtained through forward propagation calculation. Then, a correction coefficient of the predicted values and the actual values are calculated through the actual refrigerant liquid supply adjusting amounts and refrigerant valve opening degrees in different data acquisition cycles, and the model accuracy is judged according to the correction coefficient. Meanwhile, an error is propagated backward, the connection weights and the thresholds of the BP neural network model are adjusted, and iteration is continued until the correction coefficient reaches a preset value or the maximum training times.

In the above embodiment, according to the temperature and the time of the previous data acquisition cycle in two adjacent data acquisition cycles, based on the preset chilling rate threshold, the refrigerant liquid supply adjusting amount and the refrigerant valve opening degree in the latter data acquisition cycle are adjusted, so that the phase-change latent heat of the refrigerant can meet the thermal load demand of the livestock and poultry meat, and rules therein are learned through the BP neural network model, so as to establish the direct relationship between the chilling rate of the livestock and poultry meat and the liquid supply of the refrigeration system, and realize the accurate judgment of the refrigeration capacity demand. The refrigeration capacity is dynamically adjusted in real time according to the chilling rate demand of the livestock and poultry meat, so that the accurate cooling of the livestock and poultry meat is realized and the very fast chilling demand of the livestock and poultry meat is satisfied. Meanwhile, the carbon dioxide refrigerant is adopted, which meets the requirements of environmental protection. According to the cooling demand of the livestock and poultry meat, the refrigeration capacity is dynamically adjusted to realize the precise control of the refrigeration system, thus reducing the energy consumption of the system.

After a test, the method in the above embodiment is adopted to control the temperature during the cooling process of the livestock meat and the poultry meat to obtain the results in Table 1 below.

TABLE 1

| Varieties of meat | Livestock meat | Poultry meat |
|---|---|---|
| Chilling rate | >15° C./h | >22° C./h |

It is found by researching that very fast chilling treatment may promote the fast release of a large number of calcium ions into myoplasm, activate actomyosin adenosine triphosphatase, lead sarcomere contracture to cause a myofibril fragmentation index to be quickly increased, simultaneously reduce a glycolysis rate and a consumption rate of adenosine triphosphate, improve an activity of u-calpain, promote degradation of skeleton protein to dissociate from the actomyosin, and finally effectively inhibit the rigor mortis after slaughter.

Based on the same inventive concept, the present disclosure further provides an intelligent temperature control system for very fast chilling of livestock and poultry meat. The intelligent temperature control system for the very fast chilling of the livestock and poultry meat may be a personal computer, a server, or other systems for realizing the intelligent temperature control for the very fast chilling of the livestock and poultry meat mentioned above.

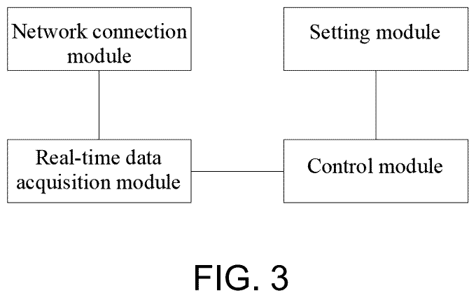

Referring to FIG. 3, the intelligent temperature control system for the very fast chilling of the livestock and poultry meat provided by the embodiments of the present disclosure comprises:
a real-time data acquisition module used for obtaining a temperature and a time of the livestock and poultry meat during a current data acquisition cycle in a cooling environment; and
a control module predicting a refrigerant liquid supply adjusting amount and a refrigerant valve opening degree of a refrigeration system in next data acquisition cycle by using a pre-trained BP neural network model according to the temperature and the time of the livestock and poultry meat during the current data acquisition cycle in the cooling environment.

All the related contents of each step involved in the above-mentioned embodiment of the intelligent temperature control method for the very fast chilling of the livestock and poultry meat may be quoted to the functional description of the functional modules corresponding to the intelligent temperature control system for the very fast chilling of the livestock and poultry meat in the embodiments of the present disclosure, and will not be repeated here.

In another embodiment, the intelligent temperature control system for the very fast chilling of the livestock and poultry meat further comprises:
a setting module used for a user to preset the specific heat capacity of the livestock and poultry meat, the time interval of the data acquisition cycles, the chilling rate threshold and the target final cooling temperature; and
a network connection module acquiring the time online through wired or wireless communication.

The division of the modules in the embodiment of the present disclosure is schematic, and is only a logical function division. There may be another division method in actual implementation. In addition, each functional module in each embodiment of the present disclosure may be integrated in one processor, or may exist physically alone, or two or more modules may be integrated in one module. The integrated modules above may be implemented in the form of hardware, or in the form of software functional modules.

In the accompanying drawings of the system embodiments provided by the present disclosure, the connection relationship between the modules indicates that there is a communication connection therebetween, which may be specifically implemented as one or more communication buses or signal lines.

The embodiments of the present disclosure further provide a device for very fast chilling of livestock and poultry meat, comprising:
a carbon dioxide refrigeration system;
a temperature sensor for acquiring the temperature of the livestock and poultry meat, a weight sensor for acquiring the weight of the livestock and poultry meat, a liquid supply sensor arranged in the carbon dioxide refrigeration system for acquiring the liquid supply of the carbon dioxide refrigerant, and an opening degree sensor arranged in the carbon dioxide refrigeration system for acquiring the valve opening degree of the carbon dioxide refrigerant;
the intelligent temperature control system for the very fast chilling of the livestock and poultry meat mentioned above, which is respectively connected with the temperature sensor, the weight sensor, the liquid supply sensor and the opening degree sensor; and
an execution unit respectively connected with the intelligent temperature control system for the very fast chilling of the livestock and poultry meat and a refrigerant valve in the carbon dioxide refrigeration system, and used for receiving an adjusting instruction sent by the intelligent temperature control system for the very fast chilling of the livestock and poultry meat, and controlling an action of the refrigerant valve in the carbon dioxide refrigeration system according to the adjusting instruction.

Specifically, the intelligent temperature control system for the very fast chilling of the livestock and poultry meat sends an adjusting instruction based on the predicted refrigerant liquid supply adjusting amount and the predicted refrigerant valve opening degree of the carbon dioxide refrigeration system in next data acquisition cycle.

Specifically, the execution unit may be an electric execution mechanism for driving a mandrel of the refrigerant valve to rotate, and the electric execution mechanism for driving the mandrel of the refrigerant valve to rotate is mature in the prior art, such as an electric execution mechanism in an electric adjusting valve, so the details are not repeated here.

The present application further provides an electronic device, which comprises: at least one processor and a memory in communication connection with the at least one processor, wherein the memory stores an instruction executable by the at least one processor, and the instruction is executed by the at least one processor to enable the at least one processor to execute the intelligent temperature control method for the very fast chilling of the livestock and poultry meat mentioned above. The electronic device may be any terminal device including a handset, a laptop computer, a desktop computer, a tablet computer, a Personal Digital Assistant (PDA), a Point of Sales (POS), an on-board computer, and the like.

The present disclosure further provides a storage medium storing a computer program thereon, wherein the computer program is executed by a processor to implement the intelligent temperature control method for the very fast chilling of the livestock and poultry meat above.

Through the description of the above embodiments, those skilled in the art may clearly understand that the present disclosure may be implemented by means of software plus necessary general hardware, and certainly, may be implemented by means of hardware including application-specific integrated circuits, special CPU, special memory, special components and the like. In general, all functions completed by computer programs may be easily realized by corresponding hardware, and the specific hardware structures used to realize the same function may also be varied, such as analog circuits, digital circuits or special circuits. However, software program implementation is a better embodiment for the present disclosure in more cases. Based on such understanding, the technical solutions of the present disclosure which essentially or contribute to the prior art, may be embodied in the form of a software product which is stored in a readable storage medium such as a floppy disc of a computer, a USB flash drive, a mobile hard disk drive, a Read-Only Memory (ROM), a Random Access Memory (RAM), a magnetic disk or an optical disk which include several instructions such that one computer device (which may be a personal computer, a server, or a network device, etc.) performs the methods described in each of the embodiments of the present disclosure.

Although the implementation of the present disclosure has been disclosed above, it is not limited to the applications listed in the specification and the embodiments, and can be fully applied to various fields suitable for the present disclosure, and additional modifications can be easily implemented by those skilled in the art. Therefore, the present disclosure is not limited to the specific details and illustrations shown and described herein without departing from the general concept defined by the claims and the equivalent scope.

What is claimed is:

1. An intelligent temperature control method for very fast chilling of livestock and poultry meat by adopting a carbon dioxide refrigeration mode, wherein the method comprises:
obtaining a temperature and a time of the livestock and poultry meat during a current data acquisition cycle in a cooling environment; and
predicting a refrigerant liquid supply adjusting amount and a refrigerant valve opening degree of a refrigeration system in next data acquisition cycle by using a pre-trained Back-propagation (BP) neural network model according to the temperature and the time of the livestock and poultry meat during the current data acquisition cycle in the cooling environment;
wherein, a method for training a BP neural network model comprises:
obtaining an initial temperature and an initial time of a livestock meat when entering the cooling environment, and recording the initial temperature and the initial time as a temperature-time sequence (T₀ᵢ, t₀ᵢ), wherein i is a serial number of different livestock and poultry meat, and there are n livestock meat and poultry meat individuals in total;
obtaining a temperature and a time of the livestock meat and poultry meat during an m^{th} data acquisition cycle in the cooling environment, and recording the temperature and the time as a temperature-time sequence (Tₘᵢ, tₘᵢ);
calculating a chilling rate Vₘᵢ=(Tₘᵢ−T₀ᵢ)/(tₘᵢ−t₀ᵢ) of the livestock and poultry meat in the m^{th} data acquisition cycle;
obtaining a preset chilling rate threshold V_{g} and a target final cooling temperature T_{g} of the livestock and poultry meat;
for each livestock and poultry meat individual, comparing Tₘᵢ with T_{g} and comparing Vₘᵢ with V_{g}; when all the livestock and poultry meat individuals satisfy that Tₘᵢ>T_{g} and Vₘᵢ≥V_{g}, a very fast chilling requirement being satisfied, and making no adjusting command; when at least one livestock and poultry meat individual satisfies that Tₘᵢ>T_{g} and Vₘᵢ≤V_{g}, the very fast chilling requirement being not satisfied, and calculating a refrigerant liquid supply adjusting amount Δq and a refrigerant valve opening degree K of an (m+1)^{th} data acquisition cycle; and when all the livestock and poultry meat individuals satisfy Tₘᵢ≤T_{g}, stopping the cooling; and
acquiring temperature-time sequences, refrigerant liquid supplies and refrigerant valve opening degrees in different data acquisition cycles, creating a training sample set of the BP neural network model, training a pre-constructed BP neural network model by using the training sample set, and adjusting a parameter of the BP neural network model by adopting a back propagation algorithm until the model converges or reaches maximum training times;
wherein, a method for calculating the liquid supply adjusting amount Δq in the (m+1)^{th} data acquisition cycle comprises:
obtaining a weight Mᵢ and specific heat capacity cᵢ of each livestock and poultry meat that does not satisfy the very fast chilling requirement;
calculating a thermal load difference (ΔQ_{total difference}=ΣΔQ_{differencei}) of all the livestock and poultry meat that does not satisfy the very fast chilling requirement in the (m+1)^{th} data acquisition cycle, wherein ΔQ_{difference i} is a thermal load difference of single livestock and poultry meat that does not satisfy the very fast chilling requirement, ΔQ_{difference i}=cᵢ·V_{g}·Mᵢ·(V_{g}·Δt−Vₘᵢ·Δt), and Δt is a time interval of the data acquisition cycles;
obtaining preset phase-change latent heat Δh of the carbon dioxide refrigerant, and calculating phase change heat (Q_{phase-change}=Δq·Δh·Δt) of the refrigerant liquid supply adjusting amount Δq in the (m+1)^{th} data acquisition cycle; and
based on that Q_{phase-change}≥ΔQ_{total difference}, deriving that Δq≥Σ[cᵢ·Mᵢ·(V_{g}−Vₘᵢ)]/Δh.

2. The intelligent temperature control method for the very fast chilling of the livestock and poultry meat according to claim 1, wherein a method for calculating the refrigerant valve opening degree K comprises:
based on a mapping relationship q=f(k) between the refrigerant liquid supply q and the valve opening degree K, deriving the refrigerant valve opening degree kₘ₊₁=f⁻¹[qₘ+Δq] in the (m+1)^{th} data acquisition cycle by calculating, wherein qₘ is a refrigerant liquid supply in the m^{th} data acquisition cycle.

3. The intelligent temperature control method for the very fast chilling of the livestock and poultry meat according to claim 2, wherein the time interval Δt of the data acquisition cycles is preset by a user.

4. The intelligent temperature control method for the very fast chilling of the livestock and poultry meat according to claim 1, wherein the livestock and poultry meat comprises all varieties of livestock and poultry meat, and parts of the livestock and poultry meat comprise carcass, sides, quarters and cut meat.

5. An intelligent temperature control system for very fast chilling of livestock and poultry meat, comprising:
a real-time data acquisition module used for obtaining a temperature and a time of the livestock and poultry meat during a current data acquisition cycle in a cooling environment; and
a control module predicting a refrigerant liquid supply adjusting amount and a refrigerant valve opening degree of a refrigeration system in next data acquisition cycle by using a pre-trained BP neural network model according to the temperature and the time of the livestock and poultry meat during the current data acquisition cycle in the cooling environment;
a method for training a BP neural network model comprises:
obtaining an initial temperature and an initial time of a livestock meat when entering the cooling environment, and recording the initial temperature and the initial time as a temperature-time sequence (T₀ᵢ, t₀ᵢ), wherein i is a serial number of different livestock and poultry meat, and there are n livestock meat individuals in total;
obtaining a temperature and a time of the livestock and poultry meat during an m^{th} data acquisition cycle in the cooling environment, and recording the temperature and the time as a temperature-time sequence (Tₘᵢ, tₘᵢ);
calculating a chilling rate Vₘᵢ=(Tₘᵢ−T₀ᵢ)/(tₘᵢ−t₀ᵢ) of the livestock and poultry meat in the m^{th} data acquisition cycle;
obtaining a preset chilling rate threshold V_{g} and a target final cooling temperature T_{g} of the livestock and poultry meat;
for each livestock and poultry meat individual, comparing Tₘᵢ with T_{g} and comparing Vₘᵢ with V_{g}; when all the livestock and poultry meat individuals satisfy that Tₘᵢ>T_{g} and Vₘᵢ≥V_{g}, a very fast chilling requirement being satisfied, and making no adjusting command; when at least one livestock and poultry meat individual satisfies that Tₘᵢ>T_{g} and Vₘᵢ≤V_{g}, the very fast chilling requirement being not satisfied, and calculating a refrigerant liquid supply adjusting amount Δq and a refrigerant valve opening degree K of an (m+1)^{th} data acquisition cycle; and when all the livestock and poultry meat individuals satisfy Tₘᵢ≤T_{g}, stopping the cooling; and
acquiring temperature-time sequences, refrigerant liquid supplies and refrigerant valve opening degrees in different data acquisition cycles, creating a training sample set of the BP neural network model, training a pre-constructed BP neural network model by using the training sample set, and adjusting a parameter of the BP neural network model by adopting a back propagation algorithm until the model converges or reaches maximum training times;
wherein, a method for calculating the liquid supply adjusting amount Δq in the (m+1)^{th} data acquisition cycle comprises:
obtaining a weight Mᵢ and specific heat capacity ci of each livestock and poultry meat that does not satisfy the very fast chilling requirement;
calculating a thermal load difference (ΔQ_{total difference}=ΣΔQ_{differencei}) of all the livestock and poultry meat that does not satisfy the very fast chilling requirement in the (m+1)^{th} data acquisition cycle, wherein ΔQ_{difference i} is a thermal load difference of single livestock and poultry meat that does not satisfy the very fast chilling requirement, ΔQ_{difference i}=cᵢ·V_{g}·Mᵢ·(V_{g}·Δt−Vₘᵢ·Δt), and Δt is a time interval of the data acquisition cycles;
obtaining preset phase-change latent heat Δh of the carbon dioxide refrigerant, and calculating phase change heat (Q_{phase-change}=Δq·Δh·Δt) of the refrigerant liquid supply adjusting amount Δq in the (m+1)^{th} data acquisition cycle;
based on that Q_{phase-change}≥ΔQ_{total difference}, deriving that Δq≥Σ[cᵢ·Mᵢ·(V_{g}−Vₘᵢ)]/Δh.

6. The intelligent temperature control system for the very fast chilling of the livestock and poultry meat according to claim 5, further comprising:
a setting module used for a user to preset the specific heat capacity of the livestock and poultry meat, the time interval of the data acquisition cycles, the chilling rate threshold and the target final cooling temperature;
a network connection module acquiring a time online through wired or wireless communication.

7. A device for very fast chilling of livestock and poultry meat, comprising:
a carbon dioxide refrigeration system;
a temperature sensor for acquiring a temperature of the livestock and poultry meat, a weight sensor for acquiring the weight of the livestock and poultry meat, a liquid supply sensor arranged in the carbon dioxide refrigeration system for acquiring the liquid supply of the carbon dioxide refrigerant, and an opening degree sensor arranged in the carbon dioxide refrigeration system for acquiring the valve opening degree of the carbon dioxide refrigerant;
an intelligent temperature control system for the very fast chilling of the livestock and poultry meat according to claim 6, which is respectively connected with the temperature sensor, the weight sensor, the liquid supply sensor and the opening degree sensor; and
an execution unit respectively connected with the intelligent temperature control system for the very fast chilling of the livestock and poultry meat and a refrigerant valve in the carbon dioxide refrigeration system, and used for receiving an adjusting instruction sent by the intelligent temperature control system for the very fast chilling of the livestock and poultry meat, and controlling an action of the refrigerant valve in the carbon dioxide refrigeration system according to the adjusting instruction.

8. An electronic device, comprising: at least one processor and a memory in communication connection with the at least one processor, wherein the memory stores an instruction executable by the at least one processor, and the instruction is executed by the at least one processor to enable the at least one processor to execute the method according to claim 1.

9. An electronic device, comprising: at least one processor and a memory in communication connection with the at least one processor, wherein the memory stores an instruction executable by the at least one processor, and the instruction is executed by the at least one processor to enable the at least one processor to execute the method according to claim 2.

10. An electronic device, comprising: at least one processor and a memory in communication connection with the at least one processor, wherein the memory stores an instruction executable by the at least one processor, and the instruction is executed by the at least one processor to enable the at least one processor to execute the method according to claim 3.

11. An electronic device, comprising: at least one processor and a memory in communication connection with the at least one processor, wherein the memory stores an instruction executable by the at least one processor, and the instruction is executed by the at least one processor to enable the at least one processor to execute the method according to claim 4.
